(19) United States
(12) Patent Application Publication
(10) Pub. No.: US 2009/0138508 A1
(43) Pub. Date: May 28, 2009

(54) NETWORK-BASED INTERACTIVE MEDIA DELIVERY SYSTEM AND METHODS

(75) Inventors: Troy Tolle, Asheville, NC (US); Anthony McCune, Lawrenceville, GA (US)

Correspondence Address: WARD AND SMITH, P.A., 1001 COLLEGE COURT, P.O. BOX 867, NEW BERN, NC, 28563-0867, US

(73) Assignee: Hebraic Heritage Christian School of Theology, Inc, Atlanta, GA (US)

(21) Appl. No.: 11/946,252

(22) Filed: Nov. 28, 2007

(51) Int. Cl. G06F 17/30

(52) U.S. Cl. 707/104.1; 707/E17.009

(57) ABSTRACT

The network system and method serves to deliver interactive media presentations. The system includes a database of interactive media presentations with a computer system connected to the database. The computer system runs portal software for creating and storing the interactive media presentations. The portal software includes a producer portlet module, a content portlet and a consumer portlet. A media capture module serves to stream media content to the portlet software and a media aggregator serves to generate a timeline for data workbooks delivered to users, i.e., media presentations.

### BACKGROUND OF THE INVENTION

The present invention relates to a collaborative and interactive system and method for delivering content to users. More specifically, the present invention relates to a collaborative and interactive learning/system and method provided through student interaction, as opposed to an instructor driven course structure.

### DISCUSSION OF EXISTING SYSTEMS

In the past, education has traditionally been delivered through the physical presence of instructors and students in the same classroom, or in a classroom environment such as an auditorium into which the instruction is broadcast through video, etc. Alternatively, other systems of delivering education involve pre-video taping a class presentation, or video taping the actual delivery of a class presentation with multiple students in the classroom and with any interaction between the instructor and the students also being shown on the video tape. The video tape, or as technology permits, a DVD, can later be used to present the class at a later date to additional students, often as is done in legal bar review courses for preparation for state bar exams.

Thus, traditionally it has been difficult to reach students in remote geographic locations due to the inability of the instructors and/or the students to travel to a common meeting site where education can be delivered. In the past, students were limited to locales where they were located, and they hoped that the necessary and desired classes were being delivered at a local institution. Alternatively, those students were forced to travel great distances and arrange for housing at other locations to receive the desired education.

More recently, with the advent of the internet and advanced computer network systems, it has become possible to deliver education through such networks, particularly through the use of activated upon delivery of certain types of contents to students. These types of programs are either previously recorded and accessible through appropriate links through a conventional web browser by a student, or available as so called “webcasts” which are arranged at predetermined times, and which require preregistration and password logged access by students. The problem with these systems is that students are forced to a predetermined timetable and/or they are not able to pace themselves and monitor their progress, nor have their progress monitored by instructors delivering the educational or other type of content. Moreover, such systems are not capable of “custom tailoring” instruction to individual students.

In more recent developments, in addition to delivery of content, both static and video, current systems employed by educational institutions allow students access to a common server and database in which students can access all types of different information about their status. Included among the types of information accessible by students is their financial aid status, grades, progress towards graduation, etc. However, all of these systems suffer from a lack of flexibility, which may be required by today's lifestyles.

One current approach to addressing education support on the internet is disclosed in U.S. Pat. No. 6,988,138. That patent discloses a system for implementing education online allowing creation of courses to be taken by students online. The courses include assignments, announcements, course materials, chat and whiteboard facilities. All of these are available to the student over a network such as the internet and functionality level is provided through a tiered licensing program addressed to the needs of the institution.

However, this system also fails in that the online educational experience to the student is somewhat static in that each student will receive the same presentation, depending on tier licensing level selected, and there is no ability to customize a course to each individual student, nor to allow the student to set their own pace of progress in the educational experience. These and other problems of the prior art are overcome by the method and system described herein and will become more readily apparent from the following discussion.

### SUMMARY OF THE INVENTION

In one aspect the invention relates to a network system for delivery of interactive media presentations. The system includes an organized digital file repository of interactive media presentations and associated database of data defining media file interactions stored thereon. A computer system is connected to the database and runs portal software thereon for creating and storing the interactive media presentations. The portal software includes a portlet module having a video editor and workbook editor for editing video and static content. A content portlet serves to browse archives and the workbook editor and for accessing videos. A consumer portlet serves to transmit workbooks and video as interactive media presentations to users on the system. A media capture module serves to stream media content to the portlet software to a media aggregator which serves to generate a timeline for media workbooks delivered to users.

In a more specific aspect, the workbook editor is configured for capturing video, reading a time stamp thereon, inserting the video into a player and inserting media into content areas and building a timeline. Further, the workbooks are configured for allowing interactive input by a user and for interrupting interaction with a user, and storing the workbook state at the time interaction-was stopped for being accessed at that point by the user at a later time. More specifically, the system is programmed for storing data thereon via synchronous network communications about time line, view state, media documents viewed and notes taken by the user, and for associating the data with a particular user to produce new media upon later request by the user. Yet still further, the system is also configured so that upon completion of an interactive media presentation as a media viewing script, access is granted to a new script.

In a yet still further aspect, the invention relates to a method conducted in a network system for delivering interactive media presentations substantially as described previously and as reflected in the claims originally filed with this application.

### BRIEF DESCRIPTION OF THE DRAWING

FIG. 1 is a block diagram of the system showing an overview in accordance with the invention;

FIG. 2 is a block diagram showing in greater detail the various components of the media editor of the system in accordance with the invention;

FIG. 3 is a block diagram of the system for conducting media synchronization for preparing a workbook with interactive content for users;

FIG. 4 is a block diagram of a media editor incorporated into the system of FIG. 1, showing various components thereof;

FIG. 5 shows two screen shots, the first screenshot at the top being a media unit view after entry by a user or student into that media unit view, from a webtop view shown at the bottom;

FIG. 6 is a block diagram showing the various components of the media capture module;

FIG. 7 is a screen shot of an online media editor;

FIG. 8 is a flow diagram showing the possible flows of interaction the student can take while interacting with the system to collaborate with other students and instructors, and showing the path of student interaction with the system while taking a course.

FIG. 9 shows the paths and process instructors follow for interacting with the system to create a student lesson (Study Unit).

FIG. 10 shows the process and flow of creating an assessment and publishing the assessment for students to take in a study unit.

FIG. 11 shows the flow and process of the media capture system in both hardware and software detail.

### DETAILED DESCRIPTION OF THE INVENTION

In implementing the invention, it is important to understand that while the overall system and method is novel and unobvious, that certain pieces of software are readily commercially available which when combined in accordance with the invention, provide the system and method described herein. For example, software which is usable in implementing the invention includes IBM Corporation's, Websphere, Community Addition Application Version 1.1 which is an open source application server used to run web applications. Other software includes Crosslogic's Infinity Portal Version 3.01 software which is a web based portal used to manage security, content management and presentation of materials over the web. In addition, there is learning system software also commercially available, and well known to those of ordinary skill, which provide a distance learning application for learning institutions, instructors and students.

In implementing the invention, the system supports a student-centric learning experience, a cooperative content usage model and a collection knowledge database. Learning programs are subscribed to and students can pay for course materials, including video lectures with synchronized images, text and presentation, submit course assignments, take course examinations and communicate with the learning provider. The system allows managing users and applications, and enrolls subscribers in instructional programs, track the progress within the learning programs and provide course material, sales and other relevant materials for sale over the network, for example, in electronic commerce.

One key element of the invention is that instructors are provided with a workbook editor and content management system to associate video content with lessons, assign work to students, test students on learning objectives, communicate with students, and customize the content on a student by student basis.

Thus, in accordance with the preferred embodiment of the invention, the system is an internet or intranet based portal designed in accordance with conventional specifications as are well known to those of ordinary skill in the art, for delivering interactive media presentations, for education or other purposes. The overall system provided is a combination of software and hardware and a collection of “portlets”. The system captures and digitally encodes multimedia content into industry standard formats for internet and intranet delivery, automatically stores the content in a network accessible software server for demand on delivery and delivers the content to a content producer to an online media editor to produce a time-line synchronized multimedia presentation made up of one or multiple element types such as video, audio, text, html, documents and other types of content.

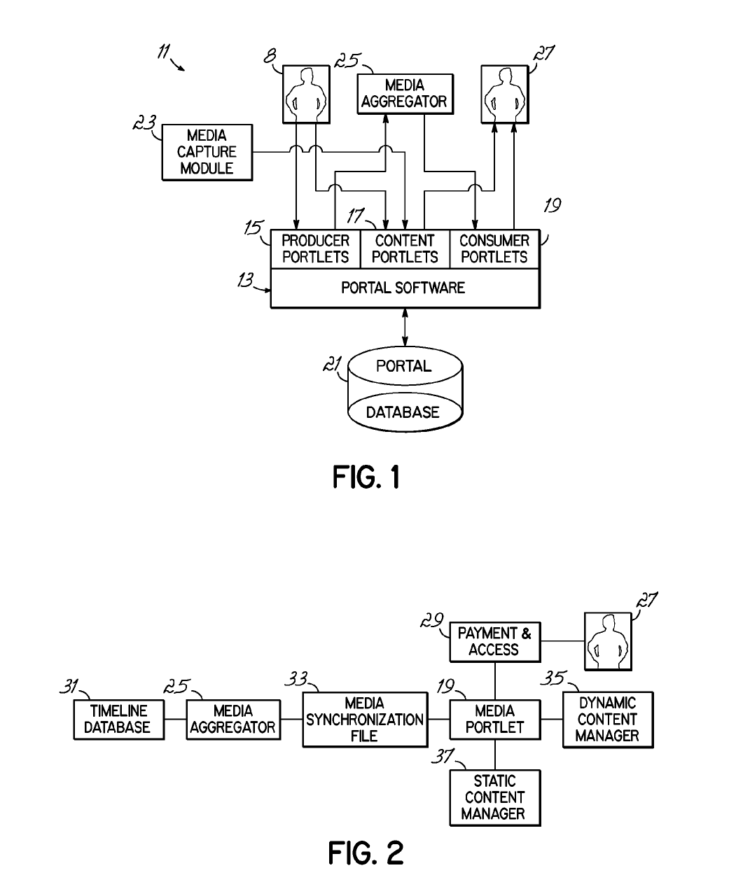

As shown in FIG. 1, the system 11 includes portal software 13 on one or more computers. The portal software 13 includes producer portlet 15 which are used for editing video and workbooks. A content portlet 17 is used to access video, browse archives, such as is contained in a database 21, and access the workbook editor. Consumer portlets 19 allow the user to connect, and the prepared workbook is delivered to the student for viewing and interacting with the media which consists of classes and/or marketing or other types of presentations. The media aggregator 25 is software which is provided in association with the portal software and operates therewith in accordance with the direction of the arrows shown to generate the timeline. It is effectively a software engine, which is the workbook editor engine. The media capture device 23 is a standard hardware module with software therein which can connect to a media acquisition device such as a camera, and includes an analog to digital conversion function to convert any acquired media into digital form.

As further shown in FIG. 2, and as provided in association with media delivery, there are shown a number of other components of the system. The media delivery system feeds presentations to registered users 27 through a media portlet 19. The users 27 register with the system and provide payment and gain access to a gateway 29. Two different types of content feed into the media portlet 19, i.e., namely a static content manager 37 provides still images and slides and a video content manager 35 provides video. The media portlet 19 cooperates through a media synchronization file module 33 with media aggregator 25 in association with timeline database 31. More specifically, the media synchronization file module 33 reads when a student is accessing the content and the media aggregator 25 pulls data about the workbook from the database to be fed to the user 27 as part of the presentation.

It is important to appreciate that with a system such as described, the content producer 28 shown in FIG. 1 can synchronize the media elements on a timeline, via synchronized communication with the server in a “drag and drop” fashion. All elements of the media presentation, i.e., media files, documents and time-line remain on a server during this process. No elements of the media editor or software except the web browser reside on the content producer's computer. The media aggregator component resides on a server and translates the content producer's instructions into a structured data set and stores it in a time-line database in database 21.

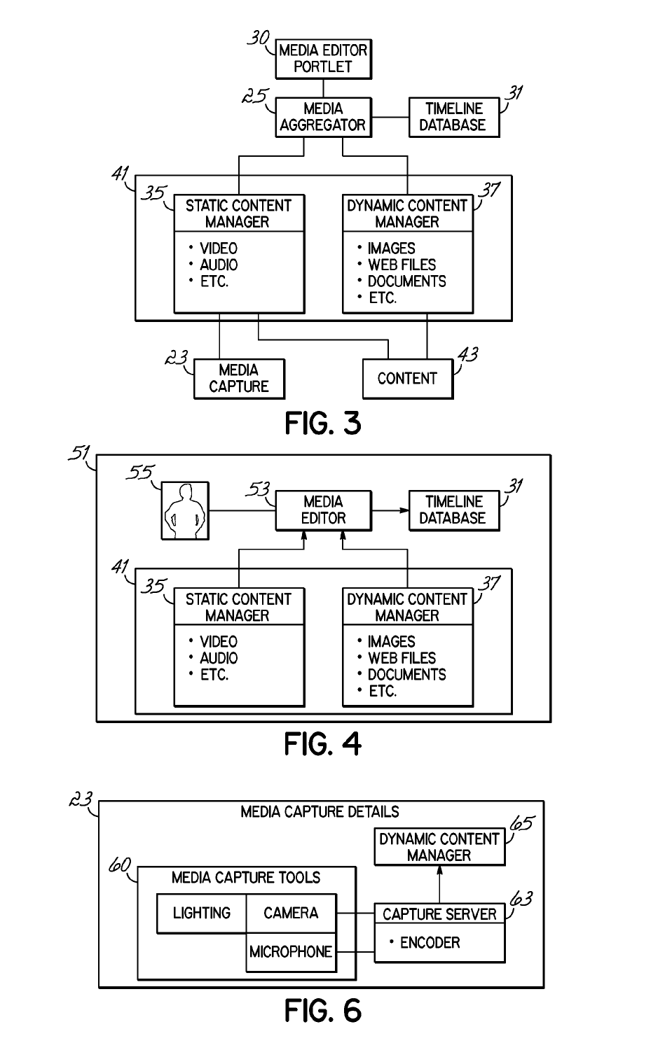

FIG. 3 is a schematic diagram showing greater details about media synchronization file generation. A media editor portlet 30 is connected to media aggregator 25 so that an instructor or producer 28 can view the various components of the presentation. The media aggregator 25 generates a time-line. More specifically it builds the time-line, inserts time stamps for triggering the population of the presentation, jumps to hyperlinks, inserts images, etc. and generally stores the presentation as a structured presentation. The time-line database 31 stores all of the elements necessary to make up a presentation as having been arranged by the previously described media aggregator 25. The content manager 41 includes the dynamic content manager 35 and static content manager 37 and views the time-line and builds the scripts for presentation to the student. The media capture module 23 generally consists of hardware and software and may be connected to a camera, video camera, lighting, etc. to capture media. In addition, a content module 43 contains already existing content for use in creating the presentation.

FIG. 4 is a schematic diagram further illustrating the media editor 51 in accordance with the invention. A producer 55 interacts with media editor module 53 which is connected to a time-line database 31 and interacts with content manager 41 which has been previously described. More specifically, FIG. 4 is a slightly different representation of what is illustrated in FIG. 3 but operates substantially along the same manner previously described.

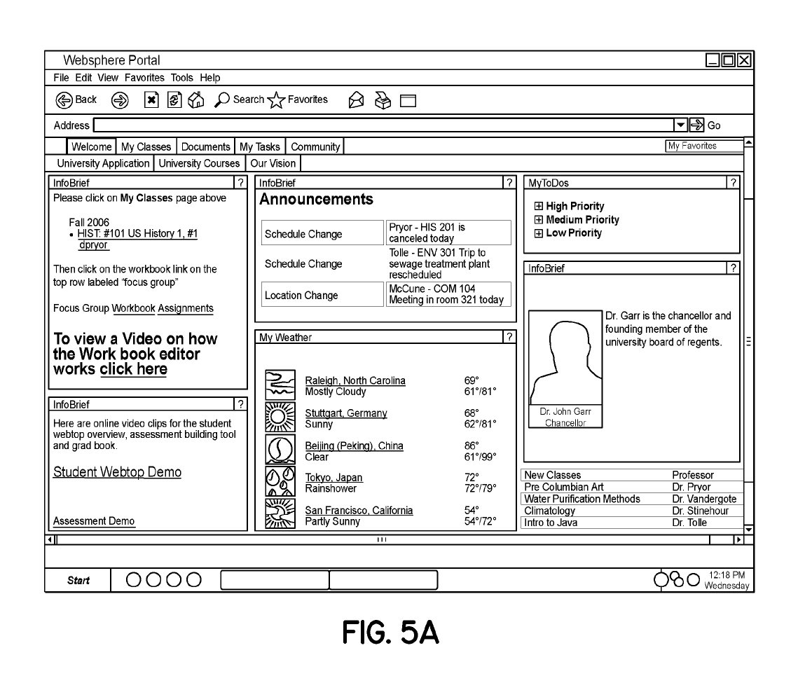

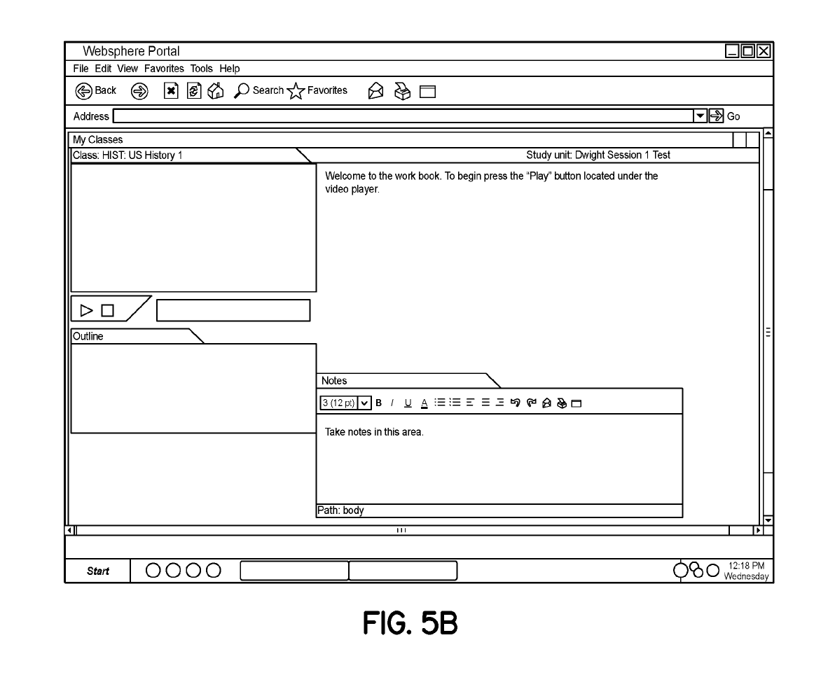

FIG. 5 illustrates at the bottom view a screen shot of how a student accesses the initial webtop and then accesses a presentation as illustrated in the screenshot at the top of the page in a representative manner.

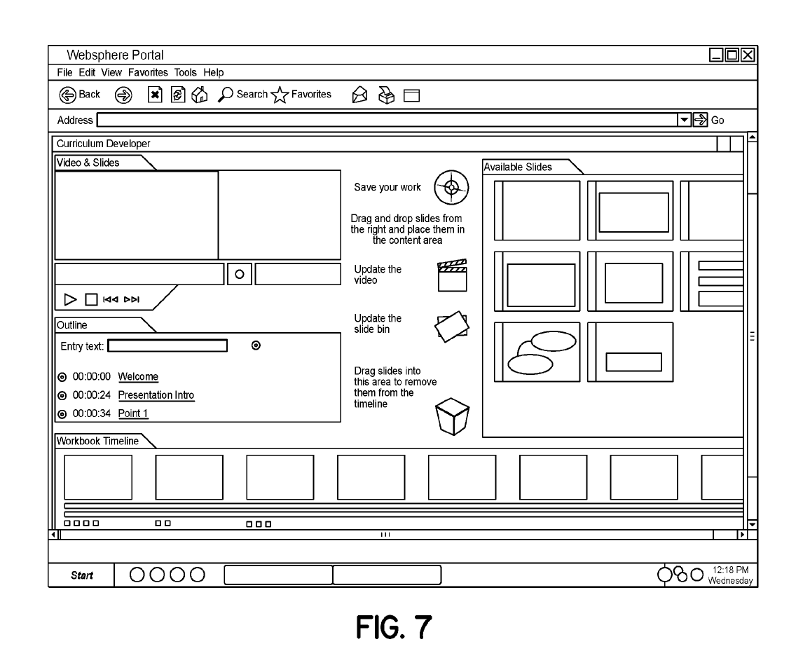

FIG. 6 is a schematic diagram further showing the media capture module 23. Media capture tools 61 can include a camera, microphone and/or lighting input which is fed to an analog to digital converter 63 and thereafter provided to the dynamic content manger 65 for streaming to the student. In this regard, FIG. 7 illustrates a screen shot of a media editor wherein the editor can drag and drop from selected content from the right to the media presentation on the left to build the presentation.

As may be appreciated from the afore description of the figures, the portal system provides an internet browser desktop view (called the webtop) which is dynamically configurable. The subscriber or student accesses the synchronized-media presentations through the webtop, based on a security profile they are granted by the system, which is based on their subscriber level. When a media unit is selected for viewing, the content aggregator retrieves the media unit time-line date from the database 21 and then generates a media viewing script that is sent through the internet or the intranet to the subscriber, via the web browser. The web browser executes the media viewing script and retrieves the media content as prescribed by the script.

Once viewing begins, the media unit stores data on the server via synchronized network communications, about the time-line view state, media elements viewed and notes that the subscriber takes in a subscriber text editor in the time-line database. The data is associated with a specific subscriber and is used by the media aggregator to produce new viewing scripts upon later request by that subscriber, as well as for use by the system for reporting. Once a media viewing script has been viewed in its entirety, a subscriber may be granted access to a new webtop element which may be included in an assessment toward the next sequential media unit in a course of study.

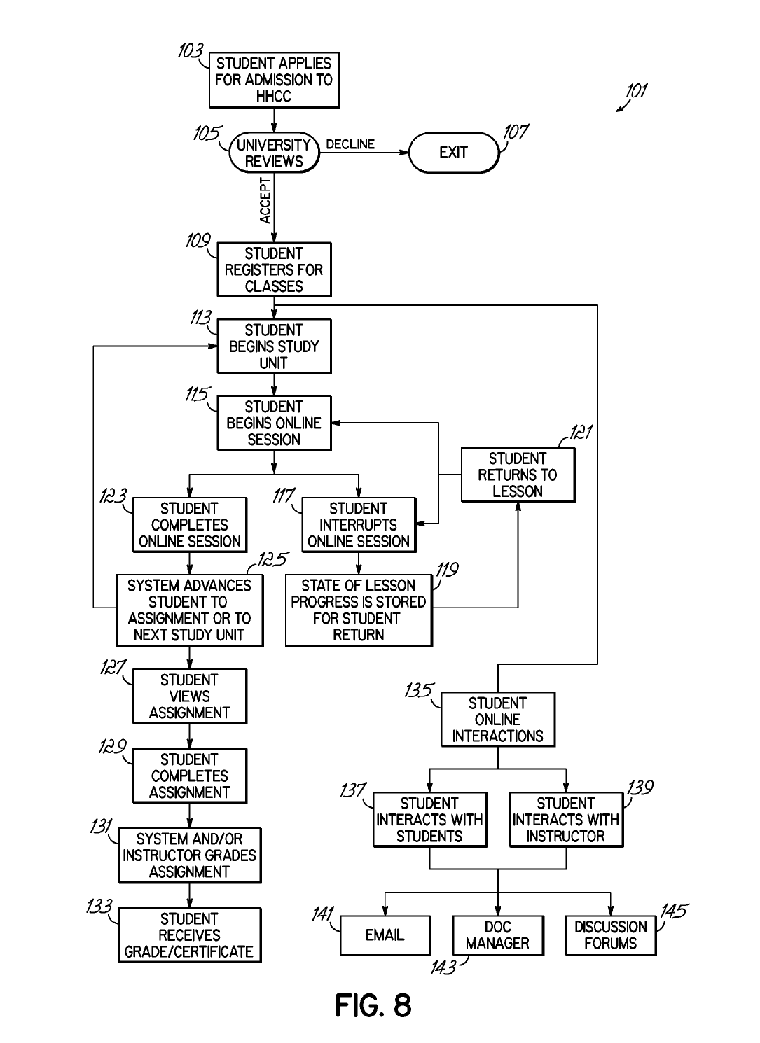

Having thus generally described the system of the invention, a process flow of students and instructors use the system is illustrated in FIGS. 8-11.

FIG. 8 illustrates the student flow of interaction as they register for an account on the system and access either the collaborative features for interacting with other students or faculty or follow the steps to access a course of study and associated assignments.

In FIG. 8, a student workflow diagram 101 is shown. In that student workflow diagram, in a first step 103, a student applies for admission to a university. At step 105 the university conducts a review of the student application and either declines the application and exits at step 107 or accepts the application and the student registers for classes at step 109. From Step 109 the process proceeds to step 113 where a student begins a study unit. At step 115 the student begins an online lesson and proceeds to a step 117 where the student can interrupt the online lesson. As an alternative to interrupting the lesson, the student can proceed to step 123 and from there at step 125 advances the student to an assignment or the next student unit. At step 127 the student views the assignment and the assignment is completed at step 129. At step 131 the system and/or the instructor grades the assignment and at step 133 the student receives a grade or certificate.

Turning back to step 117, it is also possible for the student to interrupt the online lesson. At step 119 the state of the lesson progress is stored for the student to return to the lesson. At step 121 the student can return to the lesson at either step 115 where the student begins the online lesson or can proceed back to interrupting the online lesson at step 117.

In reviewing FIG. 8, it is also possible that instead of proceeding to the lessons, the student can at step 135 engage in online interactions. Such interactions include at step 137 an interaction with students or at step 139 an interaction with the instructor. An interaction can also take the form of email as shown at block 141, a document manager at block 143 or discussions forums at block 145.

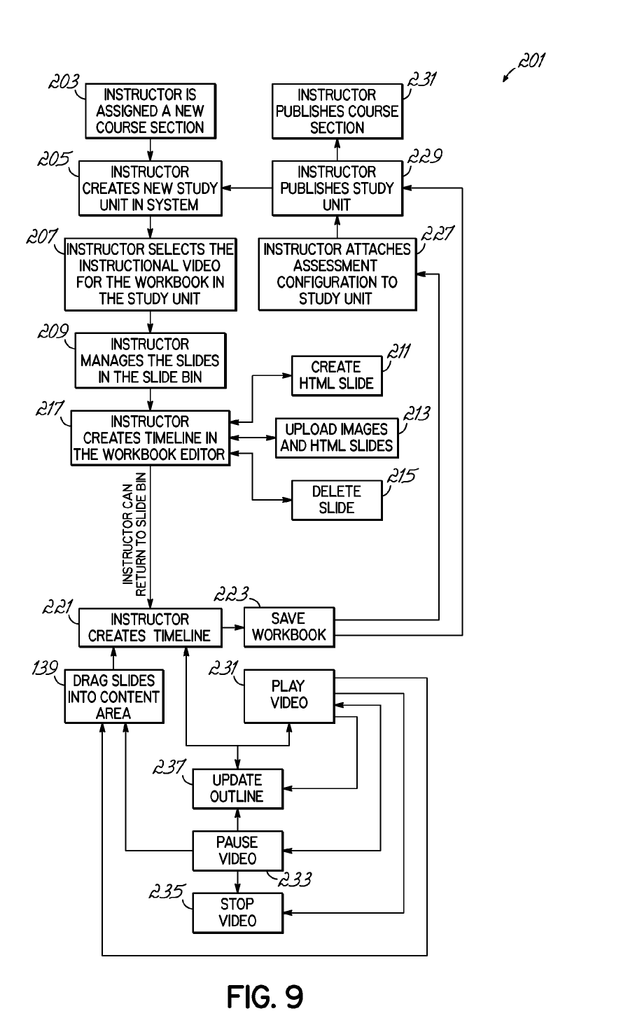

FIG. 9 illustrates the process and flow for instructors to create and publish an online lesson using the workbook editor online multimedia editing engine.

FIG. 9 is a block/flow diagram 201 illustrating how an instructor operates as an editor for courses and course sections in the system of the invention. At step 203, an instructor is assigned a new course section. Thereafter, in step 205 the instructor creates a new study unit in the system and at step 207 selects an instructional video for a work book and a study unit. A slide bin has been created and at step 209 the instructor manages the slides in the slide bin including at step 213 uploading images and HTML slides, or at step 215 deleting slides and/or at step 211 creating HTML slides. At step 217 the instructor creates a timeline in a workbook editor which is crucial for the delivery of the lessons as previously discussed. It should be noted that as shown at FIG. 9 that although at step 221 the instructor creates the timeline, the instructor can also return to the slide bin. In creating the timeline at step 221, it is important to appreciate that at a result of interactions with the system, at step 231 the instructor can play the video, and at step 237 update the outline. As part of playing the video 231, the video can be stopped at step 235 or paused at step 233, with slides being dragged into the content area at step 239, and returning to step 237 to update the outline so that the workbook can be saved at step 223.

The instructor, at step 227, attaches an assessment configuration to the study unit, or alternatively or in parallel at step 229 publishes the study unit and either returns to step 205 as before or at step 231 publishes the course section.

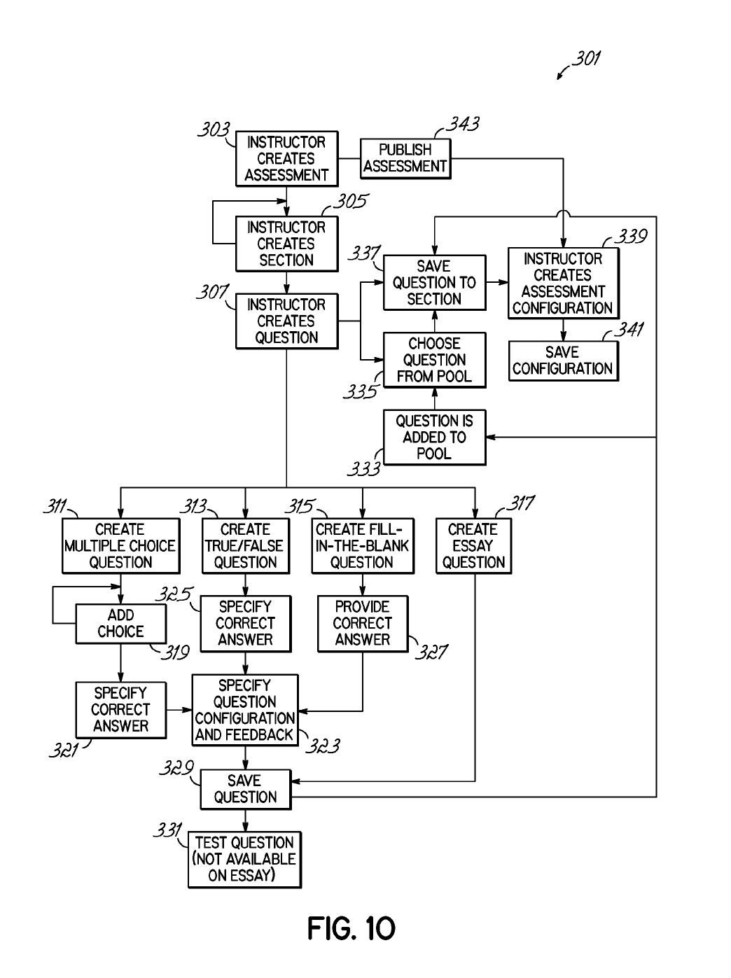

FIG. 10 illustrates the process and workflow for an instructor to create and publish an assessment to be assigned to a student in conjunction with a workbook lesson in a course study unit.

FIG. 10 shows the assessment creation flow diagram 301 in which an instructor creates an assessment at step 303. At step 305 the instructor creates a section and this can be repeated numerous times as shown by the recycle line. Thereafter, at step 307 the instructor creates a question and at that step can proceed in two different directions. As may be apparent from FIG. 10, the creation of a question can result in different types of questions being created as shown at steps 311, 313, 315 and 317. When a multiple choice true, or false, or fill in the blank question is created, it proceeds along different paths than the creation of an essay question as step 317. In the case of a multiple choice question, choices are added at step 319 and the correct answer is specified at step 321. For true and false questions, the correct answer is specified at step 325. In the case of fill in the blank questions at step 305, the correct answer is provided at step 327 and from the three different types of questions, at step 323 the question configuration and feed back is specified. At step 329 the question is saved and then included as a test question in step 331. Once the question is saved, at step 333 the question can be added to a pool of questions. At step 335 a question from the pool is chosen and at step 337 the question can be saved to the section, and at step 339 the assessment configuration is created and thereafter saved to step 341.

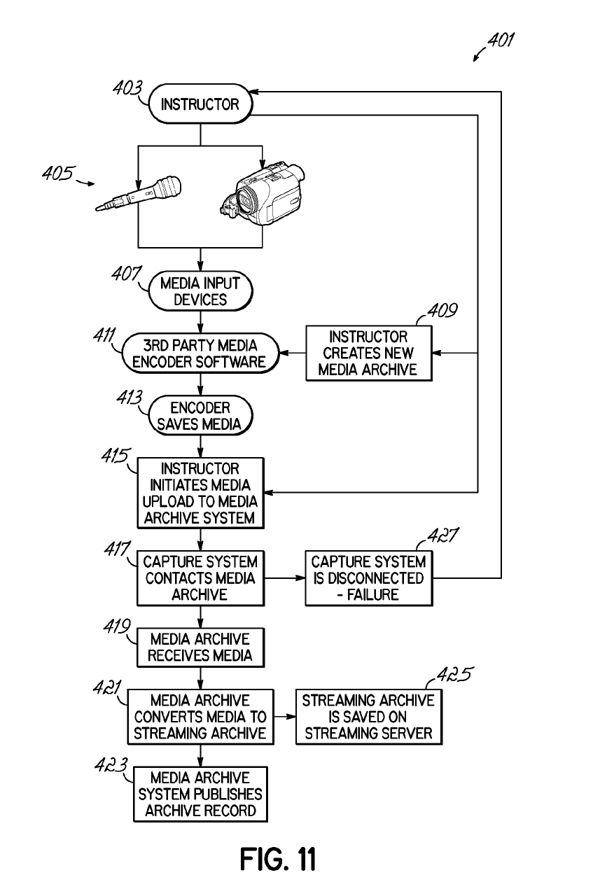

Finally, FIG. 11 illustrates the media capture system flow and the process of using media capture devices to generate multimedia video or audio files that are automatically stored in a media repository for use in a student workbook as illustrated in FIG. 9a and 9b.

FIG. 11 is a flow diagram 401 of how media capture flow occurs. At step 403 an instructor operates media capture devices 405 which can take many forms as is well know to those of ordinary skill. The media input devices at step 407 provide input into third party media encoder software 411. Similarly, the instructor 403 can create a new media archive at step 409 which is also input into the third party media encoder software at step 411. At step 413, the encoder saves the media and at step 415 the instructor initiates media upload to a media archive system.

At step 417 the system contacts the media archive and at step 419 the media archive receives the media so alternatively, the capture system can be disconnected at step 427 due to a failure and the instructor can start all over again.

If the media archive receives the media at step 419, then the archive coverts the media to streaming archive at step 421, and at the same time the media archive system publishes the archive record at step 423 or the streaming archive is saved on a streaming sever at step 425.

Having thus generally described the invention, the same will become better understood from the appended claims in which are set forth in a non-limiting manner.

What is claimed is:

1. A network system for delivery of interactive media presentations, comprising:
an organized digital file repository of interactive media presentations and associated database of data defining the media file interactions;
a computer system connected to said files and database running portal software thereon for creating and storing said interactive media presentations;
said portal software further comprising, a producer portlet module having a video editor and workbook editor for editing video and static content, a content portlet for browsing archives and the workbook editor, and for accessing videos, and
a consumer portlet for transmitting workbooks and video as an interactive media presentations to users on the system;
a media capture module for streaming media content to the portlet software; and
a media aggregator for generating a timeline for data workbooks delivered to users.

2. The system of claim 1, wherein said workbook editor is configured for capturing video, reading a time stamp thereon, inserting the video into a player, inserting media into content areas and building a timeline.

3. The system of claim 2, wherein said media capture module is configured for capturing media with a media capture device and further comprising software on said capture device for pushing the media into the system.

4. The system of claim 3, wherein said media capture device is a camera.

5. The system of claim 3, wherein said media capture module further comprises an analog to digital converter for converting any captured media into digital format.

6. The system of claim 1, wherein said computer system is programmed for allowing access to content only to users that have registered with the system.

7. The system of claim 1 wherein the computer system is programmed so that the users are presented with an Internet browser desktop.

8. The system of claim 1, wherein said workbooks are configured for allowing interactive input by a user, and for interrupting interaction with a user and storing the workbook at the time interaction was stopped for being accessed at that point by the user at a later time.

9. The system of claim 1, wherein said computer system is programmed for storing data thereon via synchronous network communications about time line, view state, media documents viewed and notes taken by a user, and for associating the data with a particular user to produce new media upon later request by the user.

10. The system of claim 9, configured such that upon completion of an interactive media presentation as a media viewing script, the computer system is programmed for granting access to a new script.

11. In a network system for delivering interactive media presentations, a method comprising:
an organized digital file repository of interactive media presentations and associated database of data defining the media file interactions;
on a computer system connected to the data base, running portal software thereon for creating and storing the interactive media presentation;
said portal software further comprising, a producer portlet and adding a video editor, and a workbook editor, and editing video and static content with said producer portlet, a content portlet and browsing archives and the workbook editor, and accessing videos with said content portlet, and a consumer portlet and transmitting workbooks and video to users on the system with said consumer portlet;
providing a media capture module and streaming media content to the portlet software therewith; and
with a media aggregator, generating a timeline for each workbook delivered to users.

12. The method of claim 11, further comprising capturing video, reading a time stamp thereon, inserting the video into a player, inserting media into content areas and building a timeline with said workbook editor.

13. The method of claim 11, further comprising capturing media with said media capture module through a media capture device.

14. The method of claim 13, further comprising providing a video camera and/or microphone as the media capture device.

15. The method of claim 13, further comprising converting any captured media into digital format with the media capture device.

16. The method of claim 11, further comprising allowing access to content only to users that have registered with the system.

17. The method of claim 11, further comprising presenting the content to a user through an internet browser desktop.

18. The method of claim 11, further comprising allowing interactive input by a user, and interrupting interaction with a user and storing the user workbook media at the time interaction was stopped for being accessed at that point by the user at a later time.

19. The method of claim 11, further comprising storing data on a computer system via synchronous network communications about timeline, view state, media elements viewed, and notes taken by a user, and associating said data with a particular user to produce new media upon later request by the user.

20. The method of claim 19, further comprising, upon completion of a media viewing script, granting access to a new script to a user.
